(19) United States
(12) Patent Application Publication
(10) Pub. No.: US 2008/0182048 A1
(43) Pub. Date: Jul. 31, 2008

(54) Multizone Web

(76) Inventors: William Ouellette, Pleasanton, CA (US); Nikhil Dani, Pleasanton, CA (US)

Correspondence Address: THE CLOROX COMPANY, P.O. BOX 24305, OAKLAND, CA, 94623-1305, US

(21) Appl. No.: 11/626,990

(22) Filed: Jan. 25, 2007

(51) Int. Cl. B32B 1/06; B32B 3/26

(52) U.S. Cl. 428/34.1; 428/316.6; 428/321.1

(57) ABSTRACT

A fibrous material suitable for a wipe, cleaning implement or any other purpose has multiple functional zones that are distinctly separated. The functional areas or zones are created in the fibrous structure by essentially eliminating the porous structure in the border regions between the different zones to create a capillary barrier. The elimination of the porous structure in this border region eliminates the passage of fluids between the zones and allows for both wet and dry zones.

### BACKGROUND OF THE INVENTION

1. Field of the Invention

The present invention relates to a fibrous material or web suitable for a wipe, cleaning implement or any other purpose where the fibrous material has multiple functional zones that are distinctly separated. The functional areas or zones are created in the fibrous structure by essentially eliminating the porous structure in the border regions between the different zones. The elimination of the porous structure in this border region essentially prohibits the passage of fluids between the zones.

2. Description of the Related Art

Different zones in nonwovens have typically been created by forming laminated structures of nonwoven layers having distinctly different properties, for example, U.S. Pat. No. 6,168,849 to Braverman et al. describes the different functional layers of a diaper. U.S. Pat. No. 6,329,308 to Kenmochi et al. describes a wipe with improved durability formed by bonding a base sheet to a separate layer by a plurality of heat-seal lines and having an edge that is fixed with heat-seal spots. The heat-seal lines can either run parallel or cross to form a grid pattern and give the wipe greater durability. U.S. patent application 2003/0172457 to Pilling et al. describes disposable bedding with a patch of absorbent material attached to a sheet by heat sealing. U.S. Pat. No. 5,487,932 to Dunshee describes a fluid storage container and applicator device that has a fluid containing pad inside a pocket of fluid impermeable material with a temporary seal, that may be a heat seal. U.S. Pat. No. 5,938,650 to Baer et al. describes an absorbent diaper core of nonwoven layers heat sealed together along a plurality of intersecting lines to define a plurality of flat, closed, porous pockets, with the intersecting seal lines defining flow channels between pockets.

Various methods have been disclosed to achieve both wet and dry wiping. U.S. Pat. No. 4,902,283 to Rojko et al. describes a reversible bag with a water-repellent liner that can be used wet and then turned inside out to dry a surface. U.S. Pat. No. 4,837,078 to Harrington describes a disposable wipe with separate wet and dry facings on opposite sides that are designed to clean up both wet and dry spills. U.S. Pat. No. 5,595,807 to Gooding, Jr. et al. describes a wet dry wipe with the wet and dry layer separated by an impermeable separating layer. U.S. patent application 2003/0116464 to Koenig et al. describes a cleaning system which includes the combination of wiping with a dry product and wiping with a wet product where the wet product and the dry product are packaged together. U.S. patent application 2006/0151351 to Hughes describes a package having two separate compartments for a dry wipe and a wet wipe. U.S. patent application 2004/0120988 to Masting describes a dry paper towel roll with a wet wipe container located within the core of the paper towel.

There are many different methods for cleaning soils from surfaces. Vacuum methods are useful for removing particulate matter and larger objects. Dry wiping products, including paper towels and tissue, are useful for cleaning wet surfaces or where physical force is required. The dry wiping may be aided by a spray of water, an application of a cleaning solution, or contact with a sheet or sponge containing a liquid, optionally followed by wiping of the surface with a dry wipe which is absorbent. Wet wiping allows the combination of wiping with the liquid normally applied by spraying. Still it difficult to provide both wet wiping and dry wiping in a single substrate or step. When faced with a wide array of options for cleaning a surface, it can be difficult for a user to determine which option or specific combination of options will provide maximum cleansing without requiring unreasonable effort and expense. To overcome these problems of prior art wiping substrates and wiping methods, the present invention is designed to allow the consumer to perform multiple tasks with a single substrate or in a fewer number of steps.

### BRIEF DESCRIPTION OF THE DRAWINGS

The foregoing aspects and others will be readily appreciated by the skilled artisan from the following description of illustrative embodiments when read in conjunction with the accompanying drawings, wherein:

FIG. 1 is a perspective view of one embodiment of the present invention;

FIG. 2 is a cross-sectional perspective view of the embodiment of the present invention depicted in FIG. 1 along the line A-A;

FIG. 3a is perspective view of an embodiment of the prior art;

FIG. 3b is a cross-sectional perspective view of the prior art embodiment in FIG. 3a along the line B-B;

FIG. 3c is a cross-sectional perspective view of another embodiment of the prior art;

FIG. 4 is a cross-sectional perspective view of another embodiment of the present invention;

FIG. 5 is a plan view of another embodiment of the present invention;

FIG. 6 is a plan view of another embodiment of the present invention;

FIG. 7 is a plan view of another embodiment of the present invention; and

FIG. 8 is a plan view of yet another embodiment of the present invention.

Reference will now be made to the drawings wherein like numerals refer to like parts throughout. As used herein, positional terms, such as “bottom” and “top” and the like, and directional terms, such as “up”, “down” and the like, are employed for ease of description in conjunction with the drawings. Further, the terms “interior”, “inwardly” and the like, refer to positions and directions toward the geometric center of embodiments of the present invention and designated parts thereof. The terms “exterior”, “outwardly”, and the like, refer to positions and directions away from the geometric center. None of these terms is meant to indicate that the described components must have a specific orientation except when specifically set forth. The term X-Y direction refers to orientation within the plane of the web. The term Z-direction refers to a direction orthogonal to the plane of the web.

Figures illustrating the components of this invention and the container show some conventional mechanical elements that are known and that will be recognized by one skilled in the art. The detailed descriptions of such elements are not necessary to an understanding of the invention, and accordingly, are herein presented only to the degree necessary to facilitate an understanding of the novel features of the present invention.

### SUMMARY OF THE INVENTION

In accordance with the above objects and those that will be mentioned and will become apparent below, one aspect of the present invention comprises a web that can be utilized for a variety of multiple purposes simultaneously as a result of its unique construction. Webs of the present invention are comprised of two or more zones that are separated from each other by a “capillary barrier”. This capillary barrier allows the delivery of a wet/dry wipe. Webs of the present invention can be used as a wipe that is delivered to the end user, containing both a dry area for absorbing and a wet area for fluid delivery.

In accordance with the above objects and those that will be mentioned and will become apparent below, another aspect of the present invention comprises webs that contain two different fluids separated by a capillary barrier that is used to deliver the two separate fluids to a surface for interaction on the surface.

In accordance with the above objects and those that will be mentioned and will become apparent below, another aspect of the present invention comprises a web containing multiple zones separated by capillary barriers with each zone performing a function based on the presence, or absence, of fluid or active contained within each zone.

In accordance with the above objects and those that will be mentioned and will become apparent below, another aspect of the present invention comprises a web containing two capillary zones within the X-Y plane of the web separated by a capillary barrier; wherein the capillary barrier substantially prevents the passage of liquid between the separated capillary zones; and wherein one separated capillary zone is wet and the other separated capillary zone is dry.

In accordance with the above objects and those that will be mentioned and will become apparent below, another aspect of the present invention comprises a web containing at least two capillary zones within the X-Y plane of the web separated by a capillary barrier; wherein the capillary barrier substantially prevents the passage of liquid between the separated capillary zones.

In accordance with the above objects and those that will be mentioned and will become apparent below, another aspect of the present invention comprises a dispensing container comprising a container having a container body and an aperture; and a web comprising a nonwoven layer having one or more capillary barriers separating two or more capillary zones within the X-Y plane of the web.

### DETAILED DESCRIPTION OF THE INVENTION

Before describing the present invention in detail, it is to be understood that this invention is not limited to particularly exemplified systems that may, of course, vary. It is also to be understood that the terminology used herein is for the purpose of describing particular embodiments of the invention only, and is not intended to limit the scope of the invention in any manner.

All publications, patents and patent applications cited herein, whether supra or infra, are hereby incorporated by reference in their entirety to the same extent as if each individual publication, patent or patent application was specifically and individually indicated to be incorporated by reference. The citation of any document is not to be construed as an admission that it is prior art with respect to the present invention.

As used herein, forms of the words “comprise”, “have”, and “include” are legally equivalent and open-ended and do not exclude additional unrecited elements, compositional components, or method steps. Accordingly, the term “comprising” encompasses the more restrictive terms “consisting essentially of” and “consisting of”.

It must be noted that, as used in this specification and the appended claims, the singular forms “a,” “an” and “the” include plural referents unless the content clearly dictates otherwise. Thus, for example, reference to a “surfactant” includes two or more such surfactants.

Unless defined otherwise, all technical and scientific terms used herein have the same meaning as commonly understood by one of ordinary skill in the art to which the invention pertains. Although a number of methods and materials similar or equivalent to those described herein can be used in the practice of the present invention, the preferred materials and methods are described herein.

In the application, effective amounts are generally those amounts listed as the ranges or levels of ingredients in the descriptions, which follow hereto. All percentages, ratios and proportions are by weight, and all temperatures are in degrees Celsius (° C.), unless otherwise specified. All measurements are in SI units, unless otherwise specified. Unless otherwise stated, amounts listed in percentage (“%'s”) are in weight percent (based on 100% active) of the cleaning composition alone. It should be understood that every limit given throughout this specification will include every lower, or higher limit, as the case may be, as if such lower or higher limit was expressly written herein. Every range given throughout this specification will include every narrower range that falls within such broader range, as if such narrower ranges were all expressly written herein.

The term “plastic” is defined herein as any polymeric material that is capable of being shaped or molded, with or without the application of heat. Usually plastics are a homo-polymers or co-polymers of high molecular weight. Plastics fitting this definition include, but are not limited to, polyolefins, polyesters, nylon, vinyl, acrylic, polycarbonates, polystyrene, and polyurethane.

The term “capillary channels” refers to areas within the nonwoven web that allow liquid to flow within the web. The term “capillary zones” refers to areas within the nonwoven web having sufficient capillary channels to allow liquid to flow across the zones or area. The term “capillary barriers” refers to areas within the nonwoven web that lack sufficient capillary channels to allow the flow of liquids within the web.

### Materials

The substrate can be selected from the group consisting of woven substrates, nonwoven substrates, foams, laminates, films, sponges, and combinations thereof. Materials used in the present invention typically include nonwoven webs or films. The nonwoven webs, for instance, can be meltblown webs, spunbond webs, carded webs, and the like. The webs can be made from various fibers, such as synthetic or natural fibers. Nonwovens can be made of an all natural fiber material, such as cellulosic fibers, cotton linters, rayon, flax, or the like, or of an all synthetic fiber material, such as polypropylene fibers, polyester fibers, and polyethylene fibers or mixtures of natural and synthetic fibers. The synthetic fibers or filaments used in making the nonwoven material of the base web may have any suitable morphology and may include hollow or solid, straight or crimped, single component, conjugate or biconstituent fibers or filaments, and blends or mixtures of such fibers and/or filaments, as are well known in the art. Synthetic fibers can also include staple fibers which can be added to increase the strength, bulk, softness and smoothness of the base sheet. Staple fibers can include, for instance, various polyolefin fibers, polyester fibers, nylon fibers, polyvinyl acetate fibers, cotton fibers, rayon fibers, non-woody plant fibers, and mixtures thereof. In general, staple fibers are typically longer than pulp fibers. Staple fibers can increase the strength and softness of the final product. when the substrate is fibrous, it can be made by nonwoven dry forming techniques, such as air-laying, or alternatively by wet laying, such as on a papermaking machine. Other nonwoven manufacturing techniques, including, but not limited to, techniques such as adhesive bonding, melt blown, spunbonded, needle punched, carding, coforming, and hydroentanglement and lamination methods may also be used.

The substrate may be formed into individual sheets or wipes or as a continuous sheet. In continuous sheet form, it is preferred to provide means, such as partial tears or perforations across at least one dimension of the sheet, such that the continuous sheet may be subdivided prior to use to a suitable size for the particular need at hand. The absorbent carrier may comprise a wipe or cleaning pad. The wipe or cleaning pad can be used with the hand, or as part of a cleaning implement attached to a tool or motorized tool, such as one having a handle. Examples of tools using a wipe or pad include U.S. Pat. No. 6,611,986 to Seals, WO00/71012 to Belt et al., U.S. patent application 2002/0129835 to Pieroni and Foley, and WO00/27271 to Policicchio et al.

### Laminate

The nonwoven substrate can comprise one layer or more than one layer. These layers can be bonded by, but not limited to, any of the following bonding methods: thermal bonding, sonic bonding, adhesive bonding (using any of the number of adhesives including but not limited to spray adhesives, hot melt adhesives, latex-based adhesives, water-based adhesives, and the like), and directly applying nonwoven fibers onto a substrate. In a suitable embodiment, the materials are adhesively bonded with a hot melt adhesive. One such adhesive is H2031, a product Ato Findlay of Wauwatosa, Wis. In suitable embodiments, the laminate may include a barrier layer that can be water impermeable. Suitable barrier materials include polymer films (i.e. polyethylene, polypropylene, EVA, and polymer blends or coextrusions), which may be rendered extensible by methods to be described hereafter.

In one embodiment, one or more nonwoven layers are laminated to a film layer, for example as described for a breathable film in U.S. Pat. No. 4,929,303. The film layer may be water permeable or water impermeable. In one example, a spunbond-meltblown-spunbond (“SMS”) layer is backed with a waterproof polyethylene film layer. The combined layers may be heat sealed along lines to form separate areas that substantially resist the passage of liquid water in either the X-Y plane or both the X-Y plane and in the thickness or Z direction.

### DETAILED DESCRIPTION OF THE DRAWINGS

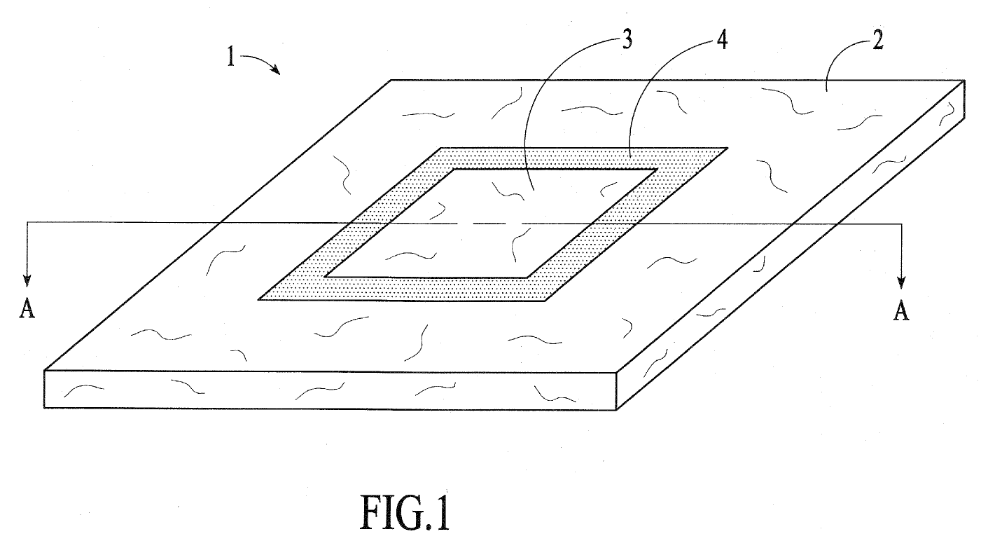

FIG. 1 is perspective view of one embodiment of the present invention. The web 1 depicted in FIG. 1 has a first zone 2 and a second zone 3 separated by a capillary barrier 4. Each of zones 2 and 3 may be capable of holding liquids in the interstitial voids formed by the structure of web 1. Capillary barrier 4 prevents the flow of liquids in the plane of the web 1 between first zone 2 and second zone 3. This barrier to liquid flow between first zone 2 and second zone 3 allows for a liquid to be loaded into one of the zones without flow to the other. In the case of web 1 shown in FIG. 1, zone 2 could be delivered with no liquid loaded therein and zone 3 delivered with a liquid suitable for cleaning, disinfecting, polishing or some other task. As web 1 is moved across a surface, zone 2 could absorb liquids present on the surface while zone 3 could deposit a functional liquid on the surface. Alternatively, if no liquid is present on the surface, zone 3 could deposit liquid onto the surface and zone 2 could remove any excess liquid deposited by zone 3. In the case of web 1 as depicted in FIG. 1, since zone 2 completely surrounds zone 3 either of these just described options would be possible without regards to the direction of movement of web 1 across the surface of interest.

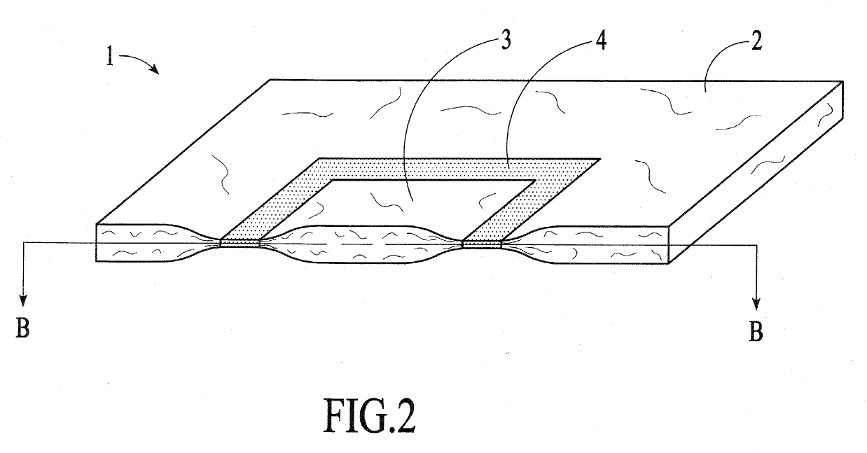

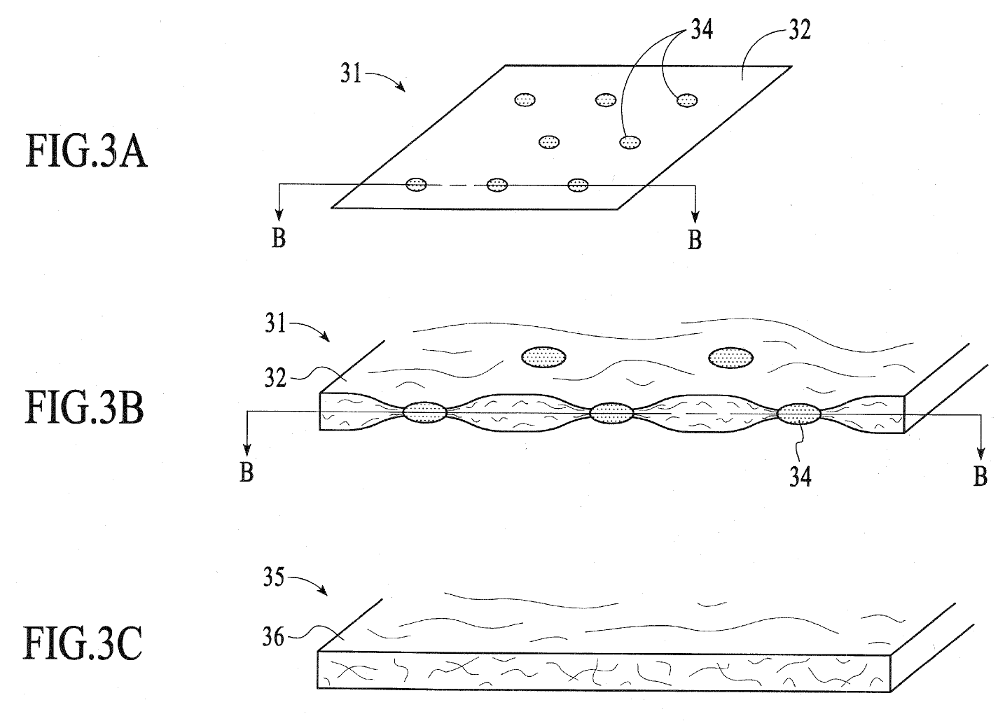

The capillary barrier 4 depicted in FIG. 1 can be a result of thermal sealing. FIG. 2 is a cross-sectional view of web 1 along the line A-A within the X-Y plane of the web. FIG. 2 shows that the thermal sealing in the region of capillary barrier 4 have essentially eliminated the capillary structure of web 1 found in zone 2 and zone 3. This lack of capillary channels in the capillary barrier 4 prevents the flow of liquids in the plane of the web 1 between zone 2 and zone 3. The thermal sealing of capillaries in the region of capillary barrier 4 is continuous within the plane of web 1 and serves to totally separate zone 2 from zone 3. This is quite different from the thermal bonding of prior art materials that use a discrete pattern of bond points, normally to maintain web integrity. FIG. 3a depicts such a web 31 of the prior art. Prior art web 31 contains discrete areas of thermal bonding 34. However the thermal bond sites 34 are not continuous and do not separate region 32 into distinct zones. FIG. 3b is a cross-sectional view of the prior art web 31 along the line B-B as depicted in FIG. 3a. It can be clearly seen in this FIG. 3b that bond sites 34, although they have locally eliminated the capillary structure are not continuous and do not divide region 32 into distinct zones. FIG. 3c is a cross-sectional perspective view of another prior art web 35. Web 35 in FIG. 3c has no bond points and is typical of webs that have been hydroentangled, needled, chemical bonded or air-through bonded without any additional treatment to reduce the capillary structure in a localized manner. There are no sites where the capillary structure has been substantially reduced or eliminated. In the case of web 35 region 36 is homogeneous and would offer no resistance to liquid flow in the plane of the web 35.

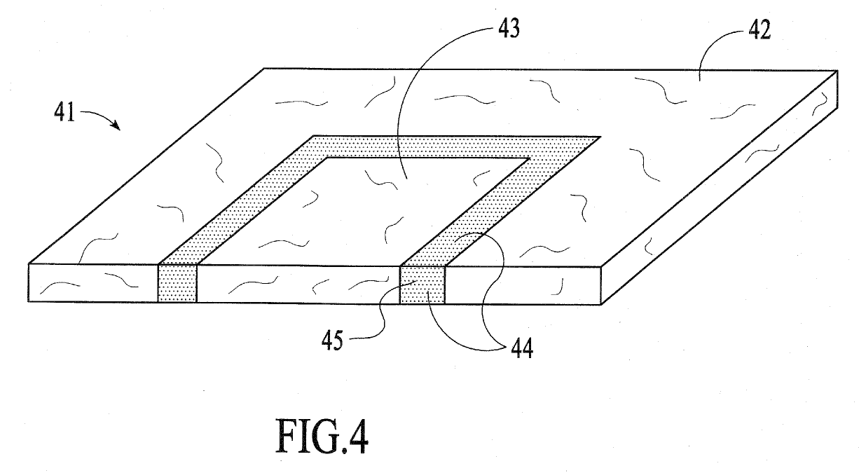

FIG. 4 is a cross-sectional perspective view of another embodiment of the present invention. FIG. 4 depicts an alternative method of creating capillary barrier 44. In FIG. 4, web 41 comprises a first zone 42 and a second zone 43 which are separated by capillary barrier 44. Capillary barrier 44 is a result of filling the capillary voids contained therein. This could be accomplished by the addition of a material 45 that will initially flow into and fill the voids of capillary barrier 44. Once inside the voids of capillary barrier 44, material 45 is immobilized in one of any suitable ways such as cooling, chemical reaction, or drying to essentially block fluid flow in the plane of web 41 between first zone 42 and second zone 43. In this way web 41 could be utilized in applications similar to web 1.

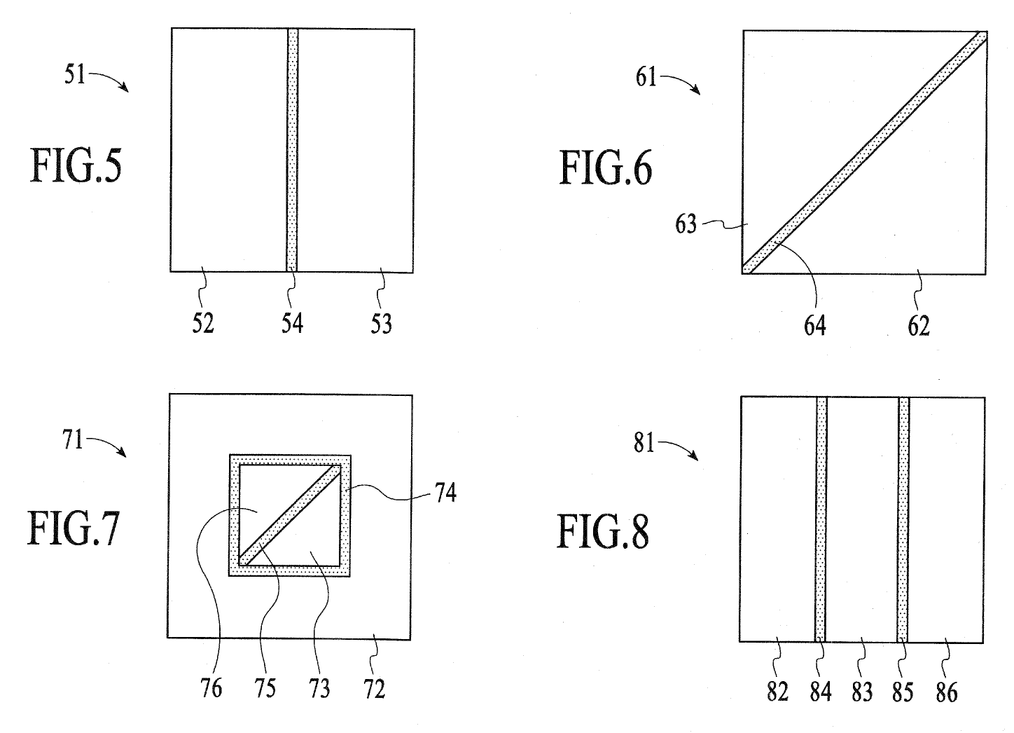

FIG. 5 is a plan view of an alternative embodiment of the present invention. Web 51 comprises a first zone 52 and a second zone 53 separated by a capillary barrier 54. FIG. 6 is a plan view of yet another alternative embodiment of the present invention. Web 61 is comprised of a first zone 62 and a second zone 63 separated by a capillary barrier 64. Both web 51 and web 61 could be utilized as wipes that absorb, clean, distribute liquids, and or combinations thereof.

FIG. 7 is a plan view of an alternative embodiment of the present invention. Web 71 is comprised of a first zone 72, a second zone 73 and a third zone 76. Second zone 73 is separated from third zone 76 by capillary barrier 75. Capillary barrier 75 prevents liquid flow, in the plane of web 71, between second zone 73 and third zone 76. Second zone 73 and third zone 76 are further separated from first zone 72 by capillary barrier 74. Capillary barrier 74 prevents liquid flow, in the plane of web 71, between second zone 73 or third zone 76 and first zone 72. Since web 71 is separated into three distinct zones, first zone 72, second zone 73 and third zone 76, each of these distinct zones could be utilized for unique fluid handling functions. For example one zone could be utilized for absorbing, another for dispensing a first liquid and the third to dispense a second liquid. In the case just mentioned the first and second liquids could be liquids that react with each other. Since the two liquids are contained in separate zones of web 71 they are separated from each other during shipping and storage by capillary barrier 75 and capillary barrier 74. However, in use, they can be dispensed in a direction orthogonal to the plane of web 71 onto a surface where they are able to mix and react. This reaction could be utilized for cleaning, indicators of contaminants or any other suitable use.

FIG. 8 is a plan of yet another embodiment of the present invention. Web 81 is comprised of first zone 82, second zone 83 and third zone 86. First zone 82 is separated from second zone 83 by capillary barrier 84. Second zone 83 is further separated from third zone 86 by capillary barrier 85. Web 81 is could be utilized for any number of application where three distinct capillary zones are useful.

Although the preceding examples depict two or three distinct capillary zones this should in no way be construed to imply that webs of the present invention could not be divided into any number of zones as needed for the application at hand.

### Capillary Barrier as Borders

In another embodiment of the present invention, the web additionally contains heat sealing along the edges or border of the layer which allows a seam or juncture which provides physical stability or a pocket to be formed. The heat seal seam is formed between the web material by pressing web between the heated elements of a heat sealing machine. The heat and pressure causes the thermoplastic fibers within the lower melting point phases to flow and fuse to form a seam thus eliminating the pore structure therein and producing a capillary barrier.

Other methods for producing a capillary barrier include adhesives, pressure bonds, ultrasonic bonds, mechanical bonds, or any other suitable means for eliminating the capillary pores or combinations of these means as are known in the art. Ultrasonic bonding is a type of fusion bonding in which the adhering or cohering mechanism is provided by the materials involved in the process. For example, with the composite material described above, it is the synthetic fibers that provide the bonding between the layers of material, hence eliminating the pore structure within the bond region. Other examples of fusion bonding include thermal bonding or heat bonding.

In addition to eliminating pores within the border region between zones, the capillary barrier can be obtained by increasing the size of the pores in the border region between zones. This increase in pore size should be sufficient to retard the flow of liquid across the border region, delineated by the increased pore size, separating one zone from another. The increased pore size will not generate sufficient capillary force to move the liquid across the barrier from one zone to the next.

### Liquid

The webs or capillary zones of suitable embodiments of the present invention can contain a liquid which can be any solution which can be absorbed into the web. The liquid contained within the wet substrates can include any suitable components which provide the desired properties. For example, the components can include water, non-aqueous liquids such as alcohol, emollients, surfactants, disinfectants, food-safe disinfectants, oxidants, bleaches including hypochlorite, preservatives, chelating agents, pH buffers, fragrances or combinations thereof. The liquid can also contain lotions, ointments and/or medicaments.

The composition can contain virtually any useful liquid compositions. Simple liquids such as water, alcohol, solvent, etc. can be useful in a variety of end uses, particularly cleaning and simple wiping applications. The liquid can be a simple cleaner, maintenance item or a personal care liquid suitable for dermatological contact with an adult, child or infant. Such compositions can be used in hospitals, schools, offices, kitchens, secretarial stations, etc. The compositions can also comprise more complex liquids in the forms of solutions, suspensions or emulsions of active materials in a liquid base. In this regard, such compositions can be active materials dissolved in an alcoholic base, aqueous solutions, water in oil emulsions, oil in water emulsions, etc. Such compositions can be cleaning materials, sanitizing materials, or personal care materials intended for contact with human skin, hair, nails, etc. Cleaning compositions used generally for routine cleaning operations not involving contact with human skin can often contain a variety of ingredients including, in aqueous or solvent base, a soil-removing surfactant, sequestrants, perfumes, etc. in relatively well-known formulations. Sanitizing compositions can contain aqueous or alcoholic solutions containing sanitizing materials such as triclosan, hexachlorophene, betadine, quaternary ammonium compounds, oxidizing agents, acidic agents, and other similar materials. Such compositions can be designed for treating or soothing human skin, including moisturizers, cleansing creams and lotions, cleansers for oily skin, deodorants, antiperspirants, baby-care products, sun block, sun screen, cosmetic-removing formula, insect repellent, etc. The amount of liquid contained within each substrate can vary depending upon the type of material being used to provide substrate, the type of liquid being used, the type of container being used to store the substrates, and the desired end use of the wet substrate.

In one embodiment, the web has a first capillary zone containing a first liquid and a second capillary zone containing a second liquid; and the first liquid and the second liquid react when mixed. Examples of suitable liquids would be an acidic containing liquid and a basic containing liquid, which could neutralize and generate heat when mixed.

### Dry Additives

The web or capillary zones of suitable embodiments of the present invention can contain a dry agent for interacting with or treating a surface. In this manner, the web or capillary zone can remain dry either in the dispenser and liquid applied during dispensing or the dry web can be wetted during use. In one embodiment, the web contains both wet and dry capillary zones, with the dry capillary zone containing a dry agent. Suitable dry agents might be antimicrobial agents, such as hypochlorite generators including calcium hypochlorite, or dyes or other agents that detect the presence of germs, such as protein detectors or specific antibody detectors. In this manner, the web could both detect and destroy germs.

### Container

The substrates may be part of dispensing container comprising a container body and an aperture and one or more nonwoven substrates therein. The term “container”, refers to, but is not limited to, packets containing one or more individual wipes or substrates and bulk dispensers, such as canisters, tubs and jars, which dispense one wipe or substrate at a time, and further feature suitable means to reseal the bulk dispenser between uses to preserve the integrity of the wipes or substrates. One example is a cylindrical canister dispenser that hosts a roll of individual wipes, separated by perforations to permit the tearing off of individual wipes for use. Such dispenser is conveniently gripped by the user and held in position while the user removes a wipe. Preferred are dispensers featuring a resealable dispensing cap and orifice (See, e.g., Chong, U.S. Pat. No. 6,554,156, of common assignment and incorporated herein by reference thereto) that dispenses individual wipes from a roll and retains the next wipe in a ready-to-dispense position, yet allows sealing of the dispensing cap to close the container against the environment when not in use. A further example, within the scope of the present invention, is to package individual wipes in a non-linked manner, in a dispenser permitting their removal one at a time, as is the case with many wipe/dispenser combinations known in the art.

There are two basic types of containers for such wet wipes namely, multi wipe containers and single wipe packages. In typical multi wipe containers, a flexible or rigid moisture impervious container is utilised, the wipes being folded and stacked in such an arrangement therein, so that a single wipe is exposed to and removed by a consumer at one time. These containers have a tub like configuration or a flexible rectangular package, both of which are typically resealable after opening. Alternatively, it has also been proposed to provide specifically designed dispensing containers, so called pop-up dispensers, to improve dispensing. These dispensers are comprised of a container having an upper panel having an orifice. The pop-up dispensers function on the principle of providing a dispensing orifice which is relatively small, and which is sized and configured so that in combination with a stack of wipes having a particular folding configuration so that the upper portion of the adjacent wipe is held within the dispensing. These containers are thus designed such that during the removal action of the upper most wipe from the container through the aperture, the adjacent wipe is elevated from the stack such that it partially protrudes through the orifice once the upper most wipe has been removed. In this manner the uppermost wipe is positioned for easy grasp by the consumer. These type of pop-up dispensers allow the wipes to be provided either on a continuous roll with perforations therein or as separately folded wipes as for example described in U.S. Pat. No. 5,560,514. Wipes are also stored in tubs as disclosed in U.S. Pat. No. 6,550,634 to Alegre De Miquel et al. and U.S. Pat. No. 6,729,498 to Yelton. These rectangular tub canisters normally contain sheets of wipes.

In one embodiment, the dispenser additionally contains a device to optionally selectively wet at least one of the capillary zones. This is a dispenser will dispense wipes and give the consumer both wet and dry zones from a dry web stored within the dispenser. In one embodiment, there will be a roll of dry wipes inside the machine that will be unrolled when needed by a crank, battery or AC operated motor. The liquid or choice of liquids will be then selected via a button or automatically, to dispense a metered or consumer controlled amount of liquid. For example, the dispenser described in U.S. Pat. No. 6,346,153 to Lake et al. can be modified to deliver liquid to only one of two capillary zones.

### Method of Use

These embodiments may further comprise method or instructions which comprise directing the user to wipe the surface with a dry portion of the product, followed by wiping the surface with a wet portion of the product. The method or instructions may also comprise directing the user to wipe the surface with a wet portion of the product, followed by wiping the surface with a dry portion of the product. The wet-dry cleaning system includes wiping the surface with a dry portion and wiping the surface with a wet portion in various sequences. The wet-dry cleaning thus includes the processes of: dry wiping, followed by dry wiping, followed by wet wiping (ddw); dry wiping, followed by wet wiping, followed by dry wiping (dwd); wet wiping, followed by dry wiping, followed by dry wiping (wdd); wet wiping, followed by wet wiping, followed by dry wiping (wwd); dry wiping, followed by wet wiping, followed by wet wiping (dww); and wet wiping, followed by dry wiping, followed by wet wiping (wdw).

The wet-dry cleaning system can be used on a wide range of surfaces. Surfaces to be cleaned include inanimate surfaces such as furniture; countertops; walls; floors; bathroom and kitchen fixtures; electronic equipment including housings and displays; interiors and exteriors of automobiles, trains, aircraft, watercraft and spacecraft; windows; industrial equipment; and electronic boards. These surfaces may, for example, contain wood, fibers, plastic, metal, cloth, ceramic, glass, paint, or minerals. Surfaces to be, cleaned also include biological surfaces, including animal body surfaces such as skin, hair, fingernails, and toenails; and the surfaces of vegetables, fruits, grains, and meats. The wet-dry cleaning system is particularly effective in cleaning soils from skin. “Soil” includes a wide range of undesirable substances which may be removed from a surface. Soil includes a wide range of biological secretions including, but not limited to, blood, feces, meconium, urine, bile, cerumen, colostrum, gastric juice, intestinal secretions, nasal secretions, menses, mucus, saliva, sebum, semen, smegma, sputum, sweat, tears, and/or vernix caseosa. Soil can also contain undigested or indigestible food; vegetable fiber such as cellulose; water; mucus; proteins; bacteria; fungi; inorganic salts; cellular debris; applied cosmetics and other foreign substances.

Substrate dispensers are convenient items that provide moistened sheets or wipes for a variety of uses. Typically, substrates are formulated for specific purposes that include infant wipes, personal care wipes, dishwashing wipes, hard surface treatment wipes, disinfectant wipes, cosmetic or sanitary wipes, hand wipes, wipes used in car cleaning, household or institutional cleaning or maintenance, computer cleaning and maintenance and any other area in which a flexible substrate having a useful liquid treatment composition has application.

While this detailed description includes specific examples according to the invention, those skilled in the art will appreciate that there are many variations of these examples that would nevertheless fall within the general scope of the invention and for which protection is sought in the appended claims.

What is claimed is:

1. A web comprising:
a. two capillary zones within the X-Y plane of the web separated by a capillary barrier;
b. wherein the capillary barrier substantially prevents the passage of liquid between the separated capillary zones; and
c. wherein one separated capillary zone is wet and the other separated capillary zone is dry.

2. The web of claim 1, wherein the web is bonded to a water-impermeable film layer.

3. The web of claim 1, wherein the web is bonded to a water-permeable film layer.

4. A web comprising:
a. at least two capillary zones within the X-Y plane of the web separated by a capillary barrier;
b. wherein the capillary barrier substantially prevents the passage of liquid between the separated capillary zones.

5. The web of claim 4, wherein at least one capillary zone contains a liquid.

6. The web of claim 4, wherein at least one capillary zone is dry.

7. The web or claim 6, wherein the dry capillary zone contains an agent for interacting with or treating a surface.

8. The web of claim 4, wherein the capillary barrier is formed by adhesives, thermal seals, pressure bonds, ultrasonic bonds, mechanical bonds or combinations thereof.

9. The web of claim 4, wherein the capillary barrier is formed by thermal sealing.

10. The web of claim 4, wherein the capillary barrier is formed by filling the capillary voids.

11. The web of claim 4, wherein the web is bonded to a water-impermeable film layer.

12. The web of claim 4, wherein the web is bonded to a water-permeable film layer.

13. The web of claim 4, wherein a first capillary zone contains a first liquid and a second capillary zone contains a second liquid; and wherein the first liquid and the second liquid react when mixed.

14. The web of claim 4, wherein the web has a single capillary barrier.

15. The web of claim 4, wherein the web has multiple capillary barriers.

16. The web of claim 4, wherein the web is formed into individual sheets.

17. The web of claim 4, wherein the web is formed as a continuous sheet.

18. The web of claim 4, wherein a first capillary zone completely surrounds a second capillary zone.

19. A dispensing container comprising:
a. a container having a container body and an aperture; and
b. a web comprising a nonwoven layer having one or more capillary barriers separating two or more capillary zones within the X-Y plane of the web.

20. The dispensing container of claim 19, wherein the dispensing container additionally contains a device to selectively wet at least one of the capillary zones.
